(19) United States
(12) Patent Application Publication
(10) Pub. No.: US 2006/0046743 A1
(43) Pub. Date: Mar. 2, 2006

(54) Group organization according to device location

(76) Inventor: Charles A. Mirho, Vancouver, WA (US)

Correspondence Address: FSP LLC, P.O. BOX 890, VANCOUVER, WA, 98666, US

(21) Appl. No.: 10/926,263

(22) Filed: Aug. 24, 2004

(51) Int. Cl. H04M 1/00

(52) U.S. Cl. 455/456.3; 455/456.1

(57) ABSTRACT

A location of a communication device is determined, and one or more characteristics associated with the communication device and/or a user or users thereof are applied to affect a determination of which of at least one other communication devices sharing an identified area or areas with the location of the communication device should be provided with a notification of the presence of the communication device or a user or users thereof.

### TECHNICAL FIELD

The present disclosure relates to device location and communication.

### BACKGROUND

People often form affinity groups sharing common interests, characteristics, and so on.

Formation of such groups may be facilitated by chat rooms and other mechanisms whereby people may communicate with one another from remote locations.

In a mobile society it may be advantageous to automatically form affinity groups based upon the location of people within, in the vicinity of, and/or approaching defined areas.

### BRIEF DESCRIPTION OF THE DRAWINGS

The headings provided herein are for convenience only and do not necessarily affect the scope or meaning of the claimed invention.

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a communication system.

FIG. 2 is an action flow diagram of an embodiment of a process of establishing affinity groups among communication devices and/or users thereof.

FIG. 3 is an action flow diagram of an embodiment of a process of determining directions between locations of communication devices in a relationship group.

FIG. 4 is an action flow diagram of an embodiment of a process of message exchange between devices in a relationship group in a communication system.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention. References to “one embodiment” or “an embodiment” do not necessarily refer to the same embodiment, although they may.

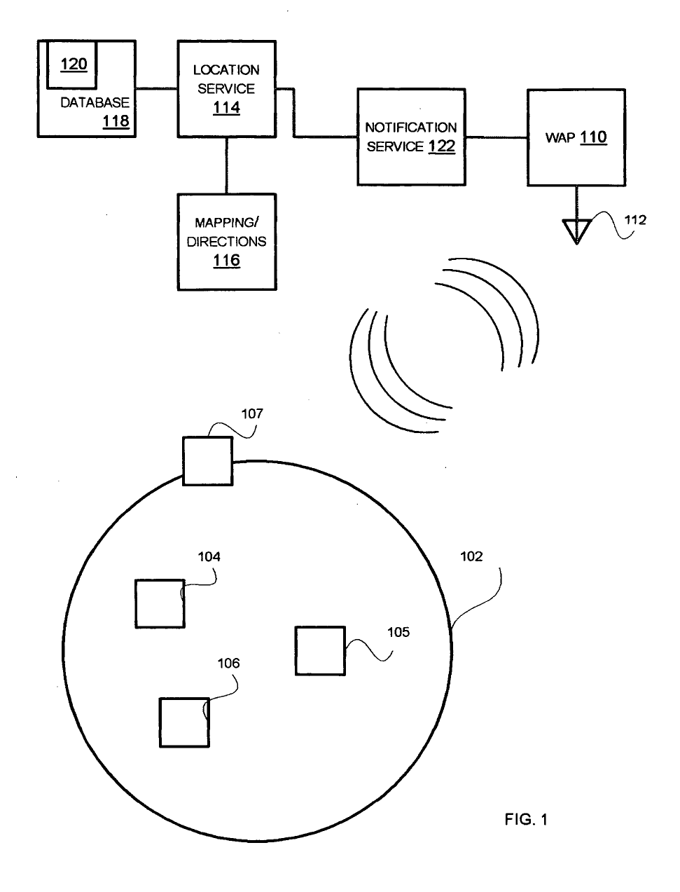

FIG. 1 is a block diagram of an embodiment of a communication system. Several communication devices 104-106 are located in a defined area 102. Another communication device 107 enters the area. In this embodiment, the communication device 107 and at least some of the other devices 104-106 are in wireless communication with a wireless access point (WAP) 112. Examples of a wireless communication device comprise a wireless phone, a laptop, palmtop, or handheld computer, an automobile computer, phone, or radio, a portable music player, a camera, or a pager. The WAP 112 enables the communications devices 104-107 to communicate with a notification service 122. The notification service 122 may be accessed from other mechanisms as well, in some embodiments including wired mechanisms such as the Internet, corporate Intranets, cable networks, telephone networks, and so on. As described more fully below, the notification service 122 may provide notifications and other information to devices within, in the vicinity of (near), and/or approaching a defined area or areas (the defined area or areas also known as an area of interest), when other devices are within, near, and/or approaching the area or areas. The notification service 122 may communicate with a location service 114 to locate various communication devices, including wireless devices 104-107. The location service 114 may communicate with a mapping/directions service(s) 116 to provide maps and/or directions for the locations of the devices. A database 118 including device and/or device user information may facilitate the notification process, as described more fully below. In the aggregate, the notification service 122, location service 114, and mapping/directions service(s) 116 are referred to herein as the Notification Application 114, 116, 122.

Devices and/or a user or users thereof may be notified of the presence of the presence of one another in an area or areas of interest. An area of interest may comprise one or more geographic areas, for example, states, cities, countries, towns, city blocks, neighborhoods, wireless cells, or cellular coverage areas. A geographic area may comprise an area within a defined radius of the communication device and/or a defined radius around one or more addresses. An area of interest may comprise one or more buildings or other structures, campuses, rooms, service establishments, retail establishments, malls, hotels, motels, parks, concert halls, restaurants, cafeterias, dormitories, recreational or fitness centers, or classrooms, to list just some of the possible examples. For example, all of the buildings for the College of Engineering for an institution of higher learning may comprise one area of interest. An area or areas of interest may be predefined with the Notification Application 114, 116, 122, possibly identified in the database 118.

An area of interest may comprise one or more regions or locations selected or determined by a communication device user via the communication device (e.g. via a cell phone or wireless-enabled laptop computer) or via other devices (such as via office or home computers). For example, a communications device user entering a cafeteria may communicate with the Notification Application 114, 116, 122 to indicate that the user or users thereof would like to join an area of interest comprising the current location and a surrounding area. Other devices in the area, and/or a user or users thereof, may have a characteristic identified as of interest to the communications device and/or user or user thereof, and/or complementary to characteristics of the device and/or a user or users thereof. Notifications may be communicated to these devices, indicating the presence in the area of the communication device and/or user/users thereof. Likewise, the communication device and/or user or users thereof may be notified of the presence of the other devices and/or user or users thereof.

If no defined area of interest comprises the device's current location, the device, and/or a user or users thereof, and/or the Notification Application 114, 116, 122, may define or participate in the definition of one. The device and/or a user or users thereof may specify one or more characteristics of interest, although this is not required (e.g. notification may occur where characteristics of the device and/or a user or users thereof are complementary with characteristics of other devices and/or users thereof in the area or areas of interest).

A communication device and/or a user or users thereof may in some embodiments associate themselves with a defined area or areas of interest in order to send and receive notifications to devices/users thereof located in, in the vicinity of, or approaching the area of interest and having a characteristic of interest, or for which the characteristics of the device and/or user or user's thereof have complementary characteristics.

By way of example, predefined areas of interest may include conference rooms and a cafeteria where a medical conference is ongoing. A neurosurgeon, caught in traffic, may communicate using his wireless device with the Notification Application 114, 116, 122 and cause the application to send a message to other neurosurgeons near, approaching, and/or within the conference areas indicating he is delayed but en route. Surgeons not within, and/or near, and/or approaching the conference areas may not receive the notification.

An area of interest may include at least one region and/or location determined heuristically (e.g. based upon criteria and/or rules applied thereto). For example, “all coffee houses within a ten mile radius”.

Determination if a device, such as 104-107, is within, and/or near, and/or approaching an area of interest may involve locating one or more wireless access points in use by, available to, and-or proximate to the device. (In the case of a wired device with no wireless capability, a wireless access point could not be used or available for that device, but it could nonetheless be nearby). Locating one or more wireless access points available to and-or proximate to the communication device may also involve locating one or more access points to a cellular network, locating one or more WiFi access points, and/or locating one or more BlueTooth access points. Global Positioning System technology may be used to determine the location of devices. In some cases, Media Access Layer (MAC) or higher level network addresses, information from other network components facilitating communication with the device, or address and/or routing information may be used to determine a device location. In some cases, the device may provide the Notification Application 114, 116, 122 with information about its location determined by the device and/or a user or users thereof.

Communication between a device, such as 107, and the Notification Application 114, 116, 122 may be triggered by movement of the device, for example, the movement of wireless device 107 into, toward, or into the vicinity of an area or areas of interest. Communication between the device and the Notification Application 114, 116, 122 may be triggered by an action of the device and/or a user or users thereof (e.g. pressing one or more buttons or keys, interacting with a touch pad, voice command, and so on). Communication between the device and the Notification Application 114, 116, 122 may be triggered by use of the WAP 112 by the device. Communication between the device and the Notification Application 114, 116, 122 may be triggered by occurrence of one or more conditions, such as the time of day, date, or the device user performing some action, such as logging on, pressing a button or initiating a command.

In some embodiments the Notification Application 114, 116, 122 may poll for or otherwise proactively locate devices/users in an area of interest. For example, the Notification Application 114, 116, 122 may interact with the WAP 112 and/or other network elements to identify devices within, near, or in movement relative to the area of interest. In another case, the notification service 122 may try to establish communication with candidate devices, either wired or wireless, by attempting once, periodically, or triggered by one or more events and/or conditions. The Notification Application 114, 116, 122 may attempt communication with devices and/or users thereof based at least in part on information about previous or potential usage and/or relationship/affinity attributes associated with a device's location(s) and/or potential location(s).

For example, the Notification Application 114, 116, 122 may identify wireless devices within a coffee shop area whose users have expressed interest in a particular baseball team. The Notification Application 114, 116, 122 may have knowledge of a third user sharing this interest. The Notification Application 114, 116, 122 may then attempt to notify the third user of the presence of the other two users within the coffee house.

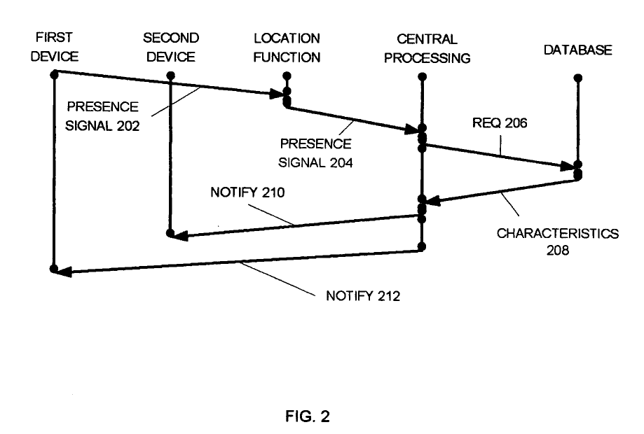

Device and/or user characteristics may comprise information about a device user's interests (for example, gardening or sports), hobbies, groups they may belong to, employment, or profession. Device and/or user characteristics may comprise information such as marital status, dating interest, age, children/their ages, appearance, sex, or even sexual preference, for example social/dating preferences. Characteristics are discussed in more detail in conjunction with FIG. 2.

The Notification Application 114, 116, 122 may obtain the device and/or user characteristics in various manners; such information may be provided by device user(s) as part of a configuration process, or determined from usage patterns/behaviors of the device and/or users, or by some other manner.

The Notification Application 114, 116, 122 may compare characteristics for a device and/or user or users thereof, to characteristics of devices and/or users thereof associated with the area or areas of interest.

A notification or notifications may be provided to the device/user identifying and/or indicating the presence of the devices/users associated with the area or areas of interest, and vice-versa. In some cases the notification may incorporate information directly provided by the user at the approximate time communication was initiated. It may also include information automatically included in the communication between the device (e.g. 107) and the Notification Application 114, 116, 122.

For example, where the device 107 is a cell phone, communication with the Notification Application 114, 116, 122 may include a mobile subscriber identification. In addition or otherwise, the communication may include descriptive information about the device/user, information about the device's/user's location, and/or indicia which may enable physical identification of the user. Other information present in the notificabon(s) may include images, audio (e.g. a recorded message), or other multimedia data. The information sent may vary depending on knowledge of the data processing and rendering capabilities of the device to which the information is being sent. For example, text might be sent to a cellular device with limited display capability, whereas a PDA having higher resolution might receive an image or graphic. In some cases, the information sent will vary depending on whether a particular user is within, near, approaching, or has some other relationship with the area of interest.

FIG. 2 is an action flow diagram of an embodiment of a process of establishing affinity groups among communication devices. At 202 the first device provides a presence signal which is communicated to the location function. The presence signal identifies the device as within, and/or near, and/or approaching an identified area or areas. The presence signal may include an identification of the first device and/or user or users thereof, such as a mobile identification code and/or serial number.

At 204 the location function provides a signal to central processing to indicate that the first device is present within, near, or approaching the area or areas of interest.

At 206 central processing provides a request to the database for information about a user corresponding to the first device, and/or for information about characteristics for the user of and/or first device, and/or for information about characteristics for other users and/or devices (such as the second device and/or a user thereof) that are within, in the vicinity of, and/or approaching the area or areas of interest.

Characteristics may include at least one of communication device features, functional capabilities, or software common to the communication device and the at least one other communication devices. Examples of communication device features include at least one of display features, sound features, performance features, or communication features. Examples of software common to the communication device and the at least one other communication devices include at least one of communication software, gaming software, communication software, social interaction software, or multimedia software. Examples of characteristics include at least one membership, interest, hobby, demographic, affinity, political, dating, or other personal or professional interest or qualification. Examples of professional interest or qualification include at least one of professional skills, experiences, favorites, educational level and-or alma mater or alma maters, present and-or former employers, identification of coworkers, professional responsibilities, professional memberships, or professional associations. Examples of characteristics include at least one of make, model, serial number, version information, or other identifications of hardware and software. Similarities with at least one characteristic may include at least one of a match with at least one characteristic, identifying one or more common parent characteristics, or a determination of substantial similarities and-or overlap among one or more characteristics and-or parent characteristics. Parent characteristics are characteristics of a group or other classification to which something belongs. Examples of personal interest or qualification include at least one of personal skills, hobbies, favorites, physical attributes, educational level and-or alma mater or alma maters, residence and-or work address or addresses, demographic attributes, family background and-or genealogy, personal memberships, or personal associations. Notifications may be provided when complementary associations exist between devices and/or users thereof. A complimentary association exists when a characteristic or characteristics of a first device and/or user or users thereof are identified as complementary to (e.g. form a desirable combination with) a characteristic or characteristics of a second device and/or user or users thereof. For example, for a user having a “single” characteristic, an interest in dating, a heterosexual orientation, and being male, a complimentary association may exist with a user indicating a single status, an interest in dating, a heterosexual orientation, and being female.

At 208 the database provides relationship information to central processing. Central processing may determine which other devices are within, near, and/or approaching the area of interest, and which have complementary characteristics with the first device and/or a user or users thereof. The second device and/or user or users thereof may fit this qualification.

At 210 central processing notifies the second device with information about the first device and/or a user or users thereof, and at 212 central processing notifies the first device with information about the second device and/or a user or users thereof.

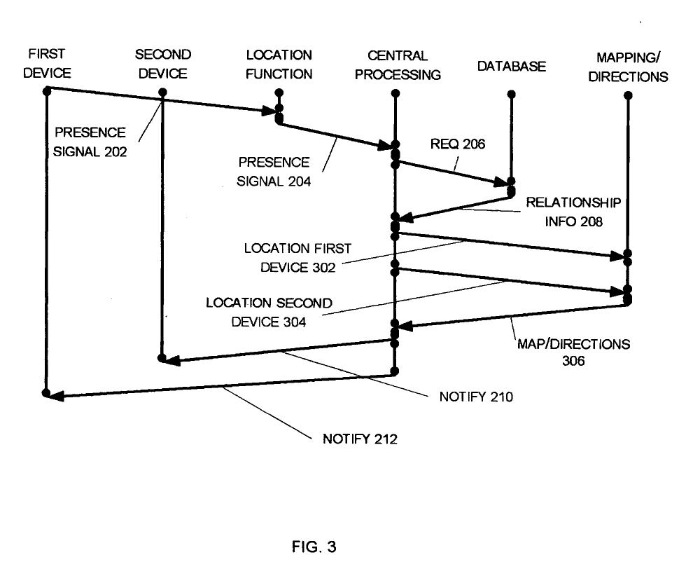

FIG. 3 is an action flow diagram of an embodiment of a process of determining directions between locations of communication devices in a relationship group. Actions 202, 204, 206, and 208 occur as described for FIG. 2.

At 302 central processing provides a location of the first device to the mapping/directions service, which may be a network-accessible geocoding, mapping, and/or routing service. At 304 central processing provides a location of the second device to the mapping/directions service.

At 306 the mapping/directions service provides a map of an area or areas comprising the first and second device, and/or directions for moving from one device to the other and visa versa, and/or relative distance between the devices, and/or distance between one or both the devices and a central point, such as the center of the area of interest, to central processing. The map may include indications of the relative locations of the devices with respect to each other and orienting location information. Examples of location information include at least one of a street address, nearby intersection or intersections, building identification, public place identification, landmark identification, hotel identification, business identification, restaurant and-or beverage facility identification, health care facility identification, entertainment facility identification, tourist attraction identification, transportation facility identification, or identification of a floor and-or wing in a building,

At 210 central processing provides a notification to the second device, and at 212 generates a notification to the first device. The notifications from central processing to the devices may include the map and/or directions information, or this information may be provided separately from the notifications.

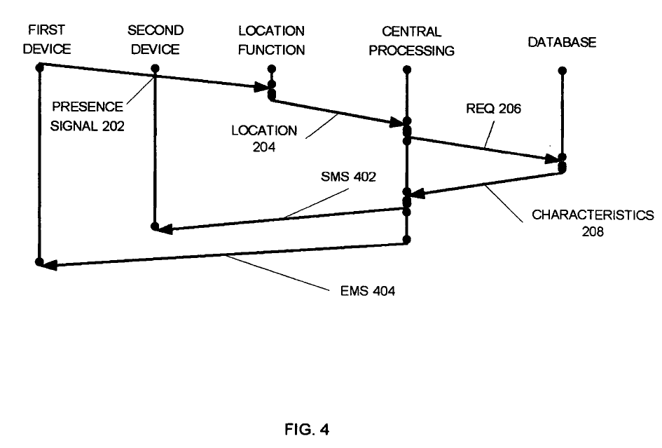

FIG. 4 is an action flow diagram of an embodiment of a process of message exchange between devices in a relationship group in a communication system. Actions 202, 204, 206, and 208 occur as described in FIG. 2.

At 402 and 404, central processing notifies the second and first communication devices respectively. Notifying communication devices may include at least one of communicating a message comprising text to the communication devices, or communicating a signal or signals that causes the communication devices to generate an audible signal and-or to vibrate. Notifying communication devices may include recorded audio messages, and/or an invitation to message exchange via chat or other means. Notification may involve automatically including a user of a device in a chat session including users of devices in the area or areas of interest.

Examples of notifying communication devices include providing a message using at least one of the Short Message Service, the Enhanced Message Service, or the Multimedia Message Service. Examples of notifying communication devices include providing at least one of text, an icon or icons, an image or images, music, a tone or tones, a jingle or jingles, a recorded sound or sounds, a recorded voice or voices, or video.

At 402 central processing provides an SMS message to the second device, identifying the first device and/or a user or users thereof (of course, the user and/or device could be identified by alias or other indirect or representative techniques). Central processing may also possibly provide location information for the first device and/or user or users thereof. Central processing may also provide the second device with information about characteristics of the first device and/or the user or users thereof.

At 404 central processing, having determined that the first device supports EMS, provides an EMS message to the first device. The EMS message may comprise an image of the user or users of the second device, or an image comprising some other characteristic of the second device and/or a user or users thereof. Thus, the nature of the notification and/or information provided by central processing may be determined according to the communication, and/or processing, and/or rendering capabilities supported by the device with which central processing is communicating.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

What is claimed is:

1. A method comprising:
determining a location of a communication device; and
applying one or more characteristics associated with the communication device and/or a user or users thereof to affect a determination of which of at least one other communication devices sharing an identified area or areas with the location of the communication device should be provided with a notification of the presence of the communication device or a user or users thereof.

2. The method of claim 1, wherein the area or areas further comprises:
one or more geographic areas.

3. The method of claim 2, wherein the one or more geographic areas further comprises:
one or more areas within a defined radius of the communication device.

4. The method of claim 3, wherein the communication device further comprises:
a wireless phone, a laptop, palmtop, or handheld computer, an automobile computer, phone, or radio, a portable music player, a camera, or a pager.

5. The method of claim 2, wherein the one or more geographic areas further comprises:
one or more zip codes, area codes, or telephone exchanges.

6. The method of claim 2, wherein the one or more geographic areas further comprises:
a defined radius around one or more addresses.

7. The method of claim 2, wherein the one or more geographic areas further comprises:
one or more states, cities, countries, towns, city blocks, neighborhoods, wireless cells, or cellular coverage areas.

8. The method of claim 1, wherein the area or areas further comprises:
one or more regions or locations selected or determined by the communication device user.

9. The method of claim 8, wherein the communication device further comprises:
a wireless phone, a laptop, palmtop, or handheld computer, an automobile computer, phone, or radio, a portable music player, a camera, or a pager.

10. The method of claim 1, wherein the area or areas further comprises:
at least one region and/or location determined heuristically.

11. The method of claim 1, wherein the determining a location of a communication device further comprises:
locating one or more wireless access points available to and/or proximate to the communication device.

12. The method of claim 11, wherein the locating one or more wireless access points available to and/or proximate to the communication device further comprises:
at least one of locating one or more access points to a cellular network, locating one or more WiFi access points, or locating one or more BlueTooth access points.

13. The method of claim 11, wherein the communication device further comprises:
a wireless phone, a laptop, palmtop, or handheld computer, an automobile computer, phone, or radio, a portable music player, a camera, or a pager.

14. The method of claim 1, wherein the determining a location of a communication device further comprises:
applying Global Positioning System technology.

15. The method of claim 1, wherein the characteristics further comprises:
at least one of communication device features, functional capabilities, or software common to the communication device and the at least one other communication devices.

16. The method of claim 15, wherein the communication device further comprises:
a wireless phone, a laptop, palmtop, or handheld computer, an automobile computer, phone, or radio, a portable music player, a camera, or a pager.

17. The method of claim 15, wherein the communication device features further comprises:
at least one of display features, sound features, performance features, or communication features.

18. The method of claim 15, wherein the software common to the communication device and the at least one other communication devices further comprises:
at least one of communication software, gaming software, communication software, social interaction software, or multimedia software.

19. The method of claim 1, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

20. The method of claim 1, wherein the characteristics further comprises:
at least one membership, interest, hobby, demographic, affinity, political, dating, or other personal or professional interest or qualification.

21. The method of claim 20, wherein the professional interest or qualification further comprises:
at least one of professional skills, experiences, favorites, educational level and/or alma mater or alma maters, present and/or former employers, identification of coworkers, professional responsibilities, professional memberships, or professional associations.

22. The method of claim 1, wherein the communication device further comprises:
a wireless phone, a laptop, palmtop, or handheld computer, an automobile computer, phone, or radio, a portable music player, a camera, or a pager.

23. The method of claim 1, wherein the characteristics further comprises:
at least one of make, model, serial number, version information, or other identifications of hardware and software.

24. A method comprising:
notifying communication devices and/or users thereof having at least one complementary characteristic of the presence of one another within, in the vicinity of, and/or approaching an identified area or areas.

25. The method of claim 24, wherein the area or areas further comprises:
one or more geographic areas.

26. The method of claim 25, wherein the one or more geographic areas further comprises:
one or more areas within a defined radius of the communication device.

27. The method of claim 26, wherein the communication device further comprises:
a wireless phone, a laptop, palmtop, or handheld computer, an automobile computer, phone, or radio, a portable music player, a camera, or a pager.

28. The method of claim 25, wherein the one or more geographic areas further comprises:
one or more zip codes, area codes, or telephone exchanges.

29. The method of claim 25, wherein the one or more geographic areas further comprises:
a defined radius around one or more addresses.

30. The method of claim 25, wherein the one or more geographic areas further comprises:
one or more states, cities, countries, towns, city blocks, neighborhoods, wireless cells, or cellular coverage areas.

31. The method of claim 24, wherein the area or areas further comprises:
one or more regions or locations selected or determined by the communication device user.

32. The method of claim 31, wherein the communication device further comprises:
a wireless phone, a laptop, palmtop, or handheld computer, an automobile computer, phone, or radio, a portable music player, a camera, or a pager.

33. The method of claim 24, wherein the area or areas further comprises:
at least one region and/or location determined heuristically.

34. The method of claim 24, wherein the notifying communication devices further comprises:
at least one of communicating a message comprising text to the communication devices, or communicating a signal that causes the communication devices to generate an audible signal and/or to vibrate.

35. The method of claim 34, wherein the communication device further comprises:
a wireless phone, a laptop, palmtop, or handheld computer, an automobile computer, phone, or radio, a portable music player, a camera, or a pager.

36. The method of claim 24, wherein the characteristics further comprises:
at least one of communication device features, functional capabilities, or software common to the communication device and the at least one other communication devices.

37. The method of claim 36, wherein the communication device further comprises:
a wireless phone, a laptop, palmtop, or handheld computer, an automobile computer, phone, or radio, a portable music player, a camera, or a pager.

38. The method of claim 36, wherein the communication device features further comprises:
at least one of display features, sound features, performance features, or communication features.

39. The method of claim 36, wherein the software common to the communication device and the at least one other communication devices further comprises:
at least one of communication software, gaming software, communication software, social interaction software, or multimedia software.

40. The method of claim 24, wherein the notifying communication devices further comprises:
an invitation to message exchange.

41. The method of claim 24, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

42. The method of claim 24, wherein the characteristics further comprises:
at least one membership, interest, hobby, demographic, affinity, political, dating, or other personal or professional interest or qualification.

43. The method of claim 42, wherein the professional interest or qualification further comprises:
at least one of professional skills, experiences, favorites, educational level and/or alma mater or alma maters, present and/or former employers, identification of coworkers, professional responsibilities, professional memberships, or professional associations.

44. The method of claim 24, wherein the communication device further comprises:
a wireless phone, a laptop, palmtop, or handheld computer, an automobile computer, phone, or radio, a portable music player, a camera, or a pager.

45. The method of claim 24, wherein the notifying communication devices further comprises:
providing a message using at least one of the Short Message Service, the Enhanced Message Service, or the Multimedia Message Service.

46. The method of claim 24, wherein the notifying communication devices further comprises:
providing at least one of text, an icon or icons, an image or images, music, a tone or tones, a jingle or jingles, a recorded sound or sounds, a recorded voice or voices, or video.

47. The method of claim 24, wherein the characteristics further comprises:
at least one of make, model, serial number, version information, or other identifications of hardware and software.

48. A method comprising:
determining a location of a communication device;
determining whether an area comprising the location of a communication device has within it, or in the vicinity of it, and/or approaching it at least one other communication device having at least one complementary characteristic with the communication device, and/or for which users of the communication device and at least one other communication device have at least one complementary characteristic; and
notifying communication devices within, in the vicinity of, and/or approaching an identified area or areas about the communication device and/or a user or users thereof, when the communication devices, and/or users thereof, have at least one complementary characteristic with the communication device and/or a user or users thereof.

49. The method of claim 48, wherein the area or areas further comprises:
one or more geographic areas.

50. The method of claim 49, wherein the one or more geographic areas further comprises:
one or more areas within a defined radius of the communication device.

51. The method of claim 50, wherein the communication device further comprises:
a wireless phone, a laptop, palmtop, or handheld computer, an automobile computer, phone, or radio, a portable music player, a camera, or a pager.

52. The method of claim 49, wherein the one or more geographic areas further comprises:
one or more zip codes, area codes, or telephone exchanges.

53. The method of claim 49, wherein the one or more geographic areas further comprises:
a defined radius around one or more addresses.

54. The method of claim 49, wherein the one or more geographic areas further comprises:
one or more states, cities, countries, towns, city blocks, neighborhoods, wireless cells, or cellular coverage areas.

55. The method of claim 48, wherein the area or areas further comprises:
one or more regions or locations selected or determined by the communication device user.

56. The method of claim 55, wherein the communication device further comprises:
a wireless phone, a laptop, palmtop, or handheld computer, an automobile computer, phone, or radio, a portable music player, a camera, or a pager.

57. The method of claim 48, wherein the area or areas further comprises:
at least one region and/or location determined heuristically.

58. The method of claim 48, wherein the notifying communication devices further comprises:
at least one of communicating a message comprising text to the communication devices, or communicating a signal that causes the communication devices to generate an audible signal and/or to vibrate.

59. The method of claim 58, wherein the communication device further comprises:
a wireless phone, a laptop, palmtop, or handheld computer, an automobile computer, phone, or radio, a portable music player, a camera, or a pager.

60. The method of claim 48, wherein the determining a location of a communication device further comprises:
locating one or more wireless access points available to and/or proximate to the communication device.

61. The method of claim 60, wherein the locating one or more wireless access points available to and/or proximate to the communication device further comprises:
at least one of locating one or more access points to a cellular network, locating one or more WiFi access points, or locating one or more BlueTooth access points.

62. The method of claim 60, wherein the communication device further comprises:
a wireless phone, a laptop, palmtop, or handheld computer, an automobile computer, phone, or radio, a portable music player, a camera, or a pager.

63. The method of claim 48, wherein the determining a location of a communication device further comprises:
applying Global Positioning System technology.

64. The method of claim 48, wherein the characteristics further comprises:
at least one of communication device features, functional capabilities, or software common to the communication device and the at least one other communication devices.

65. The method of claim 64, wherein the communication device further comprises:
a wireless phone, a laptop, palmtop, or handheld computer, an automobile computer, phone, or radio, a portable music player, a camera, or a pager.

66. The method of claim 64, wherein the communication device features further comprises:
at least one of display features, sound features, performance features, or communication features.

67. The method of claim 64, wherein the software common to the communication device and the at least one other communication devices further comprises:
at least one of communication software, gaming software, communication software, social interaction software, or multimedia software.

68. The method of claim 48, wherein the notifying communication devices further comprises:
an invitation to message exchange.

69. The method of claim 48, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

70. The method of claim 48, wherein the characteristics further comprises:
at least one membership, interest, hobby, demographic, affinity, political, dating, or other personal or professional interest or qualification.

71. The method of claim 70, wherein the professional interest or qualification further comprises:
at least one of professional skills, experiences, favorites, educational level and/or alma mater or alma maters, present and/or former employers, identification of coworkers, professional responsibilities, professional memberships, or professional associations.

72. The method of claim 48, wherein the communication device further comprises:
a wireless phone, a laptop, palmtop, or handheld computer, an automobile computer, phone, or radio, a portable music player, a camera, or a pager.

73. The method of claim 48, wherein the notifying communication devices further comprises:
providing a message using at least one of the Short Message Service, the Enhanced Message Service, or the Multimedia Message Service.

74. The method of claim 48, wherein the notifying communication devices further comprises:
providing at least one of text, an icon or icons, an image or images, music, a tone or tones, a jingle or jingles, a recorded sound or sounds, a recorded voice or voices, or video.

75. The method of claim 48, wherein the characteristics further comprises:
at least one of make, model, serial number, version information, or other identifications of hardware and software.

76. A method comprising:
storing, in a communication network, at least one identification of an area or areas;
as a result of detecting a communication device within, in the vicinity of, and/or approaching the identified area or areas, comparing at least one characteristics for the device and/or user or users thereof for complements with at least one characteristics of at least one other communication devices and/or a user or users thereof; and
notifying communication devices in the identified area or areas of the communication device having a presence within, being in the vicinity of, and/or approaching the identified area or areas, when the communication device and the at least one other communication devices, or users thereof, have at least one complementary characteristic.

77. The method of claim 76, wherein the area or areas further comprises:
one or more geographic areas.

78. The method of claim 77, wherein the one or more geographic areas further comprises:
one or more areas within a defined radius of the communication device.

79. The method of claim 78, wherein the communication device further comprises:
a wireless phone, a laptop, palmtop, or handheld computer, an automobile computer, phone, or radio, a portable music player, a camera, or a pager.

80. The method of claim 77, wherein the one or more geographic areas further comprises:
one or more zip codes, area codes, or telephone exchanges.

81. The method of claim 77, wherein the one or more geographic areas further comprises:
a defined radius around one or more addresses.

82. The method of claim 77, wherein the one or more geographic areas further comprises:
one or more states, cities, countries, towns, city blocks, neighborhoods, wireless cells, or cellular coverage areas.

83. The method of claim 76, wherein the area or areas further comprises:
one or more regions or locations selected or determined by the communication device user.

84. The method of claim 83, wherein the communication device further comprises:
a wireless phone, a laptop, palmtop, or handheld computer, an automobile computer, phone, or radio, a portable music player, a camera, or a pager.

85. The method of claim 76, wherein the area or areas further comprises:
at least one region and/or location determined heuristically.

86. The method of claim 76, wherein the notifying communication devices further comprises:
at least one of communicating a message comprising text to the communication devices, or communicating a signal that causes the communication devices to generate an audible signal and/or to vibrate.

87. The method of claim 86, wherein the communication device further comprises:
a wireless phone, a laptop, palmtop, or handheld computer, an automobile computer, phone, or radio, a portable music player, a camera, or a pager.

88. The method of claim 76, wherein the similarities with at least one characteristic further comprises:
at least one of a match with at least one characteristic, identifying one or more common parent characteristics, or a determination of substantial similarities and/or overlap among one or more characteristics and/or parent characteristics.

89. The method of claim 76, wherein the characteristics further comprises:
at least one of communication device features, functional capabilities, or software common to the communication device and the at least one other communication devices.

90. The method of claim 89, wherein the communication device further comprises:
a wireless phone, a laptop, palmtop, or handheld computer, an automobile computer, phone, or radio, a portable music player, a camera, or a pager.

91. The method of claim 89, wherein the communication device features further comprises:
at least one of display features, sound features, performance features, or communication features.

92. The method of claim 89, wherein the software common to the communication device and the at least one other communication devices further comprises:
at least one of communication software, gaming software, communication software, social interaction software, or multimedia software.

93. The method of claim 76, wherein the notifying communication devices further comprises:
an invitation to message exchange.

94. The method of claim 76, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

95. The method of claim 76, wherein the characteristics further comprises:
at least one membership, interest, hobby, demographic, affinity, political, dating, or other personal or professional interest or qualification.

96. The method of claim 95, wherein the professional interest or qualification further comprises:
at least one of professional skills, experiences, favorites, educational level and/or alma mater or alma maters, present and/or former employers, identification of coworkers, professional responsibilities, professional memberships, or professional associations.

97. The method of claim 76, wherein the communication device further comprises:
a wireless phone, a laptop, palmtop, or handheld computer, an automobile computer, phone, or radio, a portable music player, a camera, or a pager.

98. The method of claim 76, wherein the notifying communication devices further comprises:
providing a message using at least one of the Short Message Service, the Enhanced Message Service, or the Multimedia Message Service.

99. The method of claim 76, wherein the notifying communication devices further comprises:
providing at least one of text, an icon or icons, an image or images, music, a tone or tones, a jingle or jingles, a recorded sound or sounds, a recorded voice or voices, or video.

100. The method of claim 76, wherein the characteristics further comprises:
at least one of make, model, serial number, version information, or other identifications of hardware and software.

101. A method comprising:
storing, in a communication network, at least one identification of an area or areas; and
as a result of detecting a communication device within, in the vicinity of, and/or approaching the identified area or areas, notifying other communication devices within, in the vicinity of, and/or approaching the identified area or areas about the communication device and/or a user or users thereof, and providing to the other communication devices at least one membership, interest, hobby, demographic, affinity, political, dating, or other personal or professional interest or qualification of the user or users of the communication device.

102. The method of claim 101, wherein the area or areas further comprises:
one or more geographic areas.

103. The method of claim 102, wherein the one or more geographic areas further comprises:
one or more areas within a defined radius of the communication device.

104. The method of claim 103, wherein the communication device further comprises:
a wireless phone, a laptop, palmtop, or handheld computer, an automobile computer, phone, or radio, a portable music player, a camera, or a pager.

105. The method of claim 102, wherein the one or more geographic areas further comprises:
one or more zip codes, area codes, or telephone exchanges.

106. The method of claim 102, wherein the one or more geographic areas further comprises:
a defined radius around one or more addresses.

107. The method of claim 102, wherein the one or more geographic areas further comprises:
one or more states, cities, countries, towns, city blocks, neighborhoods, wireless cells, or cellular coverage areas.

108. The method of claim 101, wherein the area or areas further comprises:
one or more regions or locations selected or determined by the communication device user.

109. The method of claim 108, wherein the communication device further comprises:
a wireless phone, a laptop, palmtop, or handheld computer, an automobile computer, phone, or radio, a portable music player, a camera, or a pager.

110. The method of claim 101, wherein the area or areas further comprises:
at least one region and/or location determined heuristically.

111. The method of claim 101, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

112. The method of claim 101, wherein the communication device further comprises:
a wireless phone, a laptop, palmtop, or handheld computer, an automobile computer, phone, or radio, a portable music player, a camera, or a pager.

113. The method of claim 101, wherein the professional interest or qualification further comprises:
at least one of professional skills, experiences, favorites, educational level and/or alma mater or alma maters, present and/or former employers, identification of coworkers, professional responsibilities, professional memberships, or professional associations.

114. A method comprising:
storing, in a communication network, at least one identification of an area or areas; and
as a result of detecting a communication device within, in the vicinity of, and/or approaching the identified area or areas, notifying the communication device of the presence of other communication devices and/or users thereof within, in the vicinity of, and/or approaching the identified area or areas, and providing to the communication device identifications of a user or users of the other communication devices, and providing to the communication device at least one personal interest or qualification, and/or professional interest or qualification, and/or at least one personal attribute of, and/or at least one professional attribute of, a user or users of the other communication devices.

115. The method of claim 114, wherein the area or areas further comprises:
one or more geographic areas.

116. The method of claim 115, wherein the one or more geographic areas further comprises:
one or more areas within a defined radius of the communication device.

117. The method of claim 116, wherein the communication device further comprises:
a wireless phone, a laptop, palmtop, or handheld computer, an automobile computer, phone, or radio, a portable music player, a camera, or a pager.

118. The method of claim 115, wherein the one or more geographic areas further comprises:
one or more zip codes, area codes, or telephone exchanges.

119. The method of claim 115, wherein the one or more geographic areas further comprises:
a defined radius around one or more addresses.

120. The method of claim 115, wherein the one or more geographic areas further comprises:
one or more states, cities, countries, towns, city blocks, neighborhoods, wireless cells, or cellular coverage areas.

121. The method of claim 114, wherein the area or areas further comprises:
one or more regions or locations selected or determined by the communication device user.

122. The method of claim 121, wherein the communication device further comprises:
a wireless phone, a laptop, palmtop, or handheld computer, an automobile computer, phone, or radio, a portable music player, a camera, or a pager.

123. The method of claim 114, wherein the area or areas further comprises:
at least one region and/or location determined heuristically.

124. The method of claim 114, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

125. The method of claim 114, wherein the communication device further comprises:
a wireless phone, a laptop, palmtop, or handheld computer, an automobile computer, phone, or radio, a portable music player, a camera, or a pager.

126. The method of claim 114, wherein the personal interest or qualification further comprises:
at least one of personal skills, hobbies, favorites, physical attributes, educational level and/or alma mater or alma maters, residence and/or work address or addresses, demographic attributes, family background and/or genealogy, personal memberships, or personal associations.

127. The method of claim 114, wherein the professional interest or qualification further comprises:
at least one of professional skills, experiences, favorites, educational level and/or alma mater or alma maters, present and/or former employers, identification of coworkers, professional responsibilities, professional memberships, or professional associations.

128. A method comprising:
providing, in accordance with an identified area or areas and at least one characteristics received from a communication device, identifications of at least one other communication devices and/or a user or users thereof that are within, in the vicinity of, and/or approaching the identified area or areas, the at least one other communication devices and/or user or users thereof having the at least one characteristics and/or characteristics complementary therewith.

129. The method of claim 128, wherein the area or areas further comprises:
one or more geographic areas.

130. The method of claim 129, wherein the one or more geographic areas further comprises:
one or more areas within a defined radius of the communication device.

131. The method of claim 130, wherein the communication device further comprises:
a wireless phone, a laptop, palmtop, or handheld computer, an automobile computer, phone, or radio, a portable music player, a camera, or a pager.

132. The method of claim 129, wherein the one or more geographic areas further comprises:
one or more zip codes, area codes, or telephone exchanges.

133. The method of claim 129, wherein the one or more geographic areas further comprises:
a defined radius around one or more addresses.

134. The method of claim 129, wherein the one or more geographic areas further comprises:
one or more states, cities, countries, towns, city blocks, neighborhoods, wireless cells, or cellular coverage areas.

135. The method of claim 128, wherein the area or areas further comprises:
one or more regions or locations selected or determined by the communication device user.

136. The method of claim 135, wherein the communication device further comprises:
a wireless phone, a laptop, palmtop, or handheld computer, an automobile computer, phone, or radio, a portable music player, a camera, or a pager.

137. The method of claim 128, wherein the area or areas further comprises:
at least one region and/or location determined heuristically.

138. The method of claim 128, wherein the characteristics further comprises:
at least one of communication device features, functional capabilities, or software common to the communication device and the at least one other communication devices.

139. The method of claim 138, wherein the communication device further comprises:
a wireless phone, a laptop, palmtop, or handheld computer, an automobile computer, phone, or radio, a portable music player, a camera, or a pager.

140. The method of claim 138, wherein the communication device features further comprises:
at least one of display features, sound features, performance features, or communication features.

141. The method of claim 138, wherein the software common to the communication device and the at least one other communication devices further comprises:
at least one of communication software, gaming software, communication software, social interaction software, or multimedia software.

142. The method of claim 128, wherein the area or areas further comprises:
one or more buildings or other structures, rooms, service establishments, retail establishments, malls, hotels, motels, parks, concert halls, restaurants, cafeterias, dormitories, recreational or fitness centers, or classrooms.

143. The method of claim 128, wherein the characteristics further comprises:
at least one membership, interest, hobby, demographic, affinity, political, dating, or other personal or professional interest or qualification.

144. The method of claim 143, wherein the professional interest or qualification further comprises:
at least one of professional skills, experiences, favorites, educational level and/or alma mater or alma maters, present and/or former employers, identification of coworkers, professional responsibilities, professional memberships, or professional associations.

145. The method of claim 128, wherein the communication device further comprises:
a wireless phone, a laptop, palmtop, or handheld computer, an automobile computer, phone, or radio, a portable music player, a camera, or a pager.

146. The method of claim 128, wherein the characteristics further comprises:
at least one of make, model, serial number, version information, or other identifications of hardware and software.

147. The method of claim 128, further comprising:
providing location information for the at least one other communication devices, and/or directions between and/or distances between a location of the communication device to which the identifications of the at least one other communication devices were provided, and at least one of the other communication devices.

148. The method of claim 147, wherein the communication device further comprises:
a wireless phone, a laptop, palmtop, or handheld computer, an automobile computer, phone, or radio, a portable music player, a camera, or a pager.

149. The method of claim 147, wherein the location information further comprises:
at least one of a street address, nearby intersection or intersections, building identification, public place identification, landmark identification, hotel identification, business identification, restaurant and/or beverage facility identification, health care facility identification, entertainment facility identification, tourist attraction identification, transportation facility identification, or identification of a floor and/or wing in a building.

150. The method of claim 147, further comprising:
obtaining, from at least one of an network-accessible geocoding, mapping, or routing service, the directions between and/or distances between the location of the communication device to which the identifications of the at least one other communication devices were provided, and at least one of the other communication devices.

151. The method of claim 150, wherein the communication device further comprises:
a wireless phone, a laptop, palmtop, or handheld computer, an automobile computer, phone, or radio, a portable music player, a camera, or a pager.
